(19) United States
(12) Patent Application Publication
(10) Pub. No.: US 2021/0390774 A1
(43) Pub. Date: Dec. 16, 2021

(54) GEOLOGICAL MAP POLYGON CHECKER FOR POLYGONS IN DEPOSITIONAL ENVIRONMENT

(71) Applicant: Landmark Graphics Corporation, Houston, TX (US)

(72) Inventor: Dominic Allan Rorke, Wallingford (GB)

(21) Appl. No.: 17/281,542

(22) PCT Filed: Oct. 22, 2018
(86) PCT No.: PCT/US2018/056888

§ 371 Date: Mar. 30, 2021

(51) Int. Cl. G06T 17/05; E21B 43/16

(52) U.S. Cl. CPC G06T 17/05; E21B 43/16

(57) ABSTRACT

A method for determining validity of an arrangement of a plurality of contiguous depositional environment polygons that depict a geological region includes obtaining a plurality of polygons stored in a dataset of polygons, each polygon of the plurality of polygons assigned a different depositional environment characteristic, and the plurality of polygons representing the geological region, arranging the plurality of polygons adjacent each other using geographical coordinates of the polygons, and thereby obtain an arrangement of the plurality of polygons, determining whether the arrangement of the plurality of polygons is valid using a rule-base that includes pairs of compatible depositional environment characteristics arranged adjacent each other, and generating a map of geological polygons for a region that facilitates exploration of a natural resource

### FIELD

The present description generally relates to ensuring correct attribution of a depositional environment represented of adjacent polygons depicting the extent of present day geological formation.

### BACKGROUND

To produce hydrocarbons (e.g., oil, gas, etc.) from a desired geological formation, wellbores may be drilled that penetrate hydrocarbon-containing portions of the geological formation. The portion of the geological formation from which hydrocarbons may be produced is commonly referred to as a “production zone.” In some instances, a given geological formation may have multiple production zones spread out throughout geological formation forming a hydrocarbon play.

It is desirable to create the depositional environment, for example, the rock types, of the geological formation. By creating the depositional environment, it may be possible to determine the area in the geological formation in which hydrocarbon accumulations or prospects of a given type occur.

### BRIEF DESCRIPTION OF THE DRAWINGS

FIG. 1 illustrates a graphical user interface (GUI) provided by the software application for selecting a dataset including multiple polygons.

FIG. 2 schematically illustrates an example depositional environment.

FIG. 3 illustrates an example rule-base, according to embodiments disclosed.

FIG. 4 illustrates part of an example attribute table, according to embodiments disclosed.

FIGS. 5A-5D illustrate example GUIs provided by the software application for performing one or more corrective actions to resolve conflicting polygon pairs, according to embodiments disclosed.

FIG. 6 conceptually illustrates an example flowchart of a process of creating a depositional environment of a desired geological region, according to embodiments disclosed.

FIG. 7 illustrates a schematic diagram of an example of an environment for implementing aspects in accordance with various embodiments.

FIG. 8 illustrates a schematic diagram of a set of general components of an example computing device.

In one or more embodiments, not all of the depicted components in each figure may be required, and one or more embodiments may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The present disclosure is related to ensuring that the depositional environment characteristics assigned to polygons in geological maps are valid, identifying any incorrectly assigned depositional environment characteristics, and thereby ensuring that the depositional environment represented in the geological maps is valid.

The depositional environment is assigned to polygons arranged laterally (side-by-side) adjacent each other. As used herein, “polygon”, or variations thereof, refers to a two-dimensional (2D) representation of a geological region (e.g., an area of the Earth's surface) having a depositional environment characteristic (e.g., shallow marine, deep marine shale, etc.). Each polygon may represent a geological region having a single, discrete depositional environment characteristic at a given geological time. Stated otherwise, a polygon identifies a geological region where a certain type of depositional environment characteristic is observed. By arranging multiple adjacent and contiguous polygons, each representing different depositional environments from the same geological time, a geological map may be created.

The placement of the different polygons is determined by Walther's Law that states that “Facies adjacent to one another in a continuous vertical sequence are also accumulated adjacent to one another laterally.” Walther's Law thus defines the criteria for placing two polygons each assigned a different depositional environment characteristic next to each other. As an example, if there were two polygons, one being a polygon assigned ‘terrestrial deposits’ and the other assigned ‘deep marine’, then placing these two polygons adjacent to each other may be a breach of Walther's Law. As another example, a polygon assigned ‘shallow marine carbonate’ may not be adjacent a polygon assigned ‘deep marine shale.’ Based on the Walther's Law, a rule-base that includes a list of depositional environment characteristics that may be placed adjacent each other may be provided. According to one or more embodiments disclosed, the depositional environment is checked against the rule-base to ensure that there is no conflict between adjacent polygons (i.e., correct polygons are placed adjacent each other), and thereby obtain a valid arrangement of the polygons.

Based on the valid arrangement of the polygons, the arrangement of the different rock types in the geological period may be determined with improved certainty. By layering (stacking) polygons from different geological periods over each other, a volume of the geological region including different rock types may be obtained. For instance, a layer of polygons representing a chronologically newer depositional environment may be arranged overlapping a layer of polygons representing a chronologically older environment. From the volume of the geological region, the arrangement of the different rock types between different geological time periods in the geological region may be determined. If, for instance, the different rock types include hydrocarbon bearing rocks (e.g., shale), then the location of natural resources, such as hydrocarbons (e.g. oil, gas, etc.), in the geological region may be determined with improved certainty. However, embodiments are not limited in this regard. From the arrangement of the different rocks types, the location of other natural resources, e.g., minerals, precious metals, etc., may also be determined, without departing from the scope of the disclosure.

According to embodiments disclosed herein, one or more steps of arranging the polygons adjacent to each other to create the depositional environment, checking against the rule-base, and taking one or more corrective actions when two polygons are incorrectly placed next to each other may be performed using a software application. The multiple polygons indicating the different depositional environment characteristics may be stored in a dataset of polygons that may be accessed by the software application. A dataset may refer to a collection of items, which in this case are polygons.

Typically, the depositional environment characteristics that are indicated by the polygons may change over time. Depositional environment characteristics are assigned based on the wellbore data obtained by analyzing the cuttings in the drilling mud used in drilling operations or wellbore data obtained from wireline line operations performed in a drilled wellbore. By analyzing the cuttings obtained from a certain depth or by analyzing the wireline data obtained from a certain depth in the wellbore, geologists may predict the depositional environment characteristics of the formation at that depth.

The processes for predicting the depositional environment characteristics from a given wellbore data changes over time as the technology involved is improved. The result is that a geological region that was formerly predicted to have a depositional environment characteristic of one type may later be predicted to have a depositional environment characteristic of a different type because of the improved technology. Thus, the depositional environment characteristics indicated by the polygons in a dataset may change.

In generating the depositional environment, the software application may thus function as a quality assurance tool to ensure that the depositional environment characteristics of the polygons in a dataset are correct and ensure that the arrangement of the polygons is a valid arrangement that adheres to a define ontology.

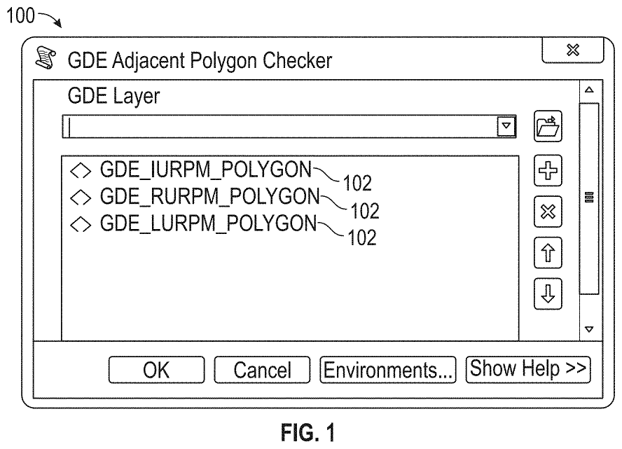

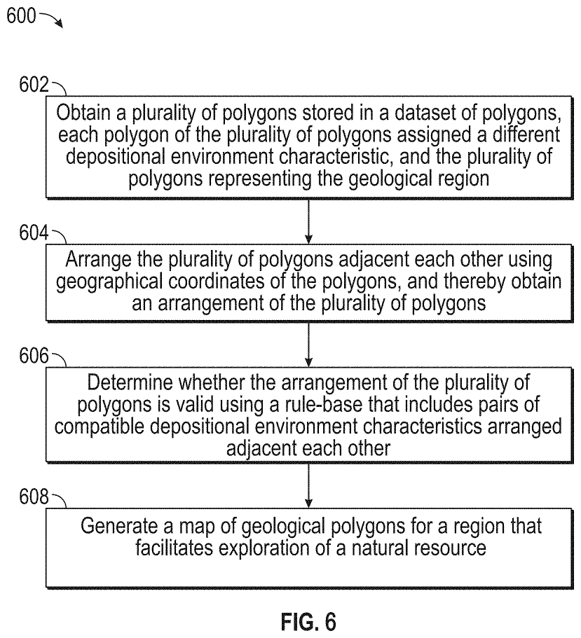

FIG. 1 illustrates a graphical user interface (GUI) 100 provided by, for example, using the web browser of the electronic device 702 (FIG. 7) for selecting a dataset including multiple polygons. As illustrated, the GUI 100 lists one or more different datasets 102 (three illustrated) each including multiple polygons.

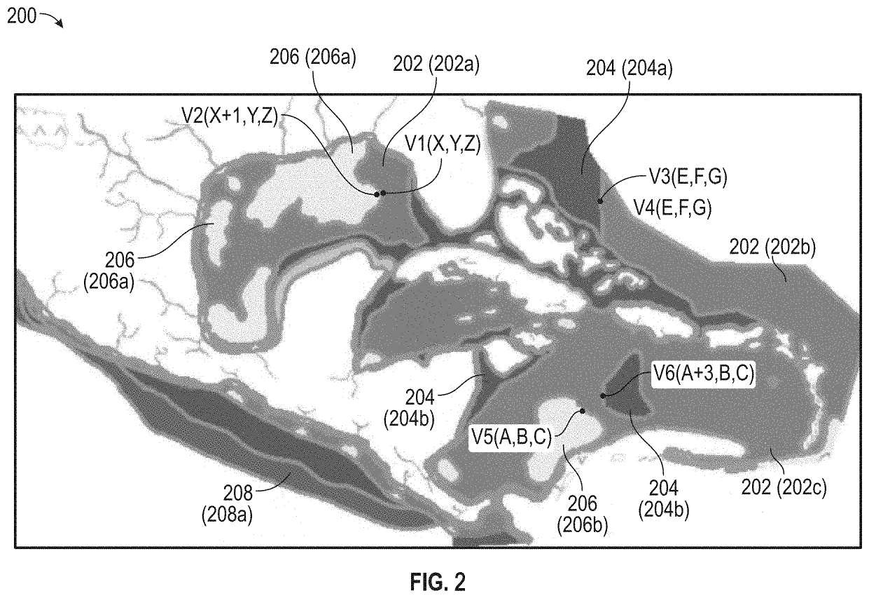

The polygons in the dataset 102 are arranged adjacent each other. Each polygon may be defined by vertices connected via lines or curves. Each vertex may have a geographical coordinate in the X, Y, and Z plane. The polygons are arranged adjacent each other based on the geographical coordinates of the polygons. FIG. 2 schematically illustrates portion of the depositional environment 200 including polygons of a selected dataset arranged adjacent each other. As illustrated, the depositional environment 200 is formed from multiple polygons 202, 204, 206, and 208, each having a different depositional environment characteristic from the same geological time.

For the sake of discussion, different instances of the same polygon are indicated as polygons 202A, 202B, 202C, 204A, 204B, etc. A polygon from the dataset 102 is selected, for instance, polygon 202A having a certain depositional environment characteristic. Polygon 202A may include a vertex V1 having co-ordinates (X, Y, Z). In order to determine a polygon that may be adjacent the polygon 202A, the geographical coordinates of the vertices of the polygon 202A may be compared with the geographical coordinates of the vertices of each of the remaining polygons 204, 206, and 208. Polygon 206A may be determined to include vertex V2 having coordinates (X+1, Y, Z), which are adjacent the co-ordinates (X, Y, Z) of the polygon 202A. As a result, polygons 202A and 206A may be placed adjacent each other when vertices thereof are determined to be geographically adjacent (next to each other and touching) each other.

Polygons may also be considered to be adjacent each other if the geographical coordinates of the vertices are the same (coinciding). For example, referring to FIG. 2, the polygon 204A includes vertex V3 having co-ordinates (E, F, G). Polygon 202B includes a vertex V4 having co-ordinates (E, F, G), which are the same as those for polygon 204A. The polygons 202B and 204A are thus arranged with the vertices V3 and V4 overlapping each other.

Polygons may also be considered to be adjacent each other if the vertices are within a predetermined geographical distance of each other. For instance, referring FIG. 2, polygon 206B may have a vertex V5 with co-ordinates (A, B, C) and polygon 204B may have a vertex V6 with co-ordinates (A+3, B, C). The vertices V5 and V6 may be considered adjacent each other since the X-coordinates are determined to be within a predetermined geographical distance of each other.

Similarly, polygons adjacent the other polygons the dataset are determined and the depositional environment of the geological region represented by the polygons 202, 204, 206, and 208 may be created. The different depositional environment characteristics assigned may include, for example, shallow marine, deep water evaporites, subaqueous winnowing, deep glaciomarine sediments, highland, and the like.

Each polygon (for example, polygons 202, 204, 206, and 208) in a dataset (e.g., dataset 102) is assigned an identifier. Based on the above process, a table may be generated (and stored in the storage medium of the electronic device 702 and/or the server 706 (FIG. 7)) that includes an identifier of each polygon (e.g., polygons 202, 204, 206, 208) and the corresponding identifiers of the polygons determined to be adjacent to the polygon. The software application may then perform an adjacency check, wherein a rule-base is referred to determine if the polygons are permitted to be adjacent each other. Specifically, the adjacency check may include comparing the depositional environment characteristics of each of the polygons determined to be adjacent.

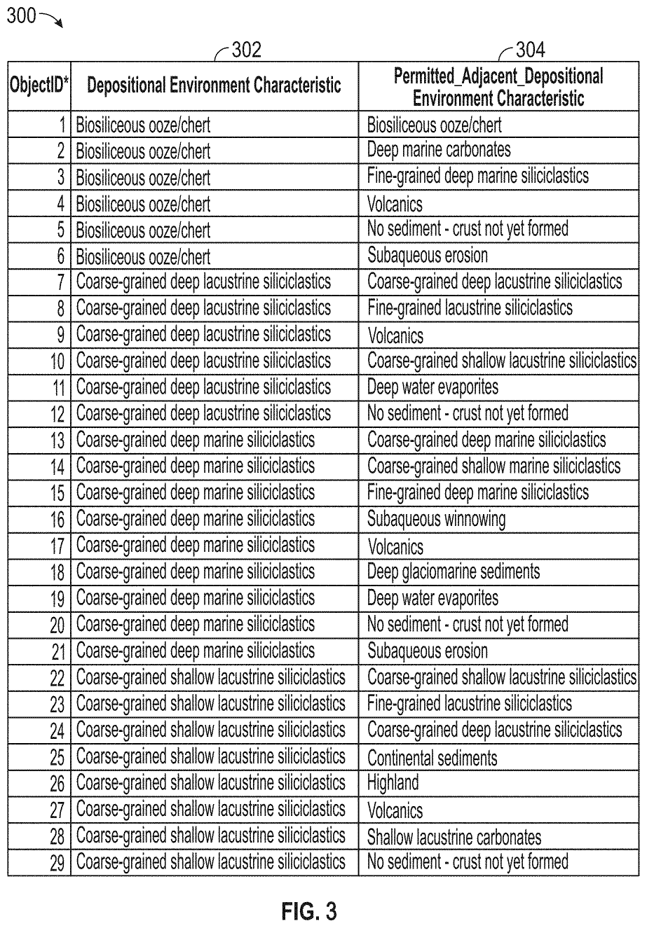

Referring briefly to FIG. 3, illustrated is an example rule-base 300, according to the embodiment disclosed. In an example, the rule-base 300 may be or include a database stored in the storage medium of the electronic device 702 and/or the server 706. As illustrated, the rule-base 300 includes pairs of compatible depositional environment characteristics that are permitted to be adjacent each other. Stated otherwise, the rule-base includes conditions that determine the depositional environment pairs according to Walther's Law. For instance, depositional environment characteristic biosiliceous ooze/chert in column 302 may be adjacent to depositional environment characteristics biosiliceous ooze/chert, deep marine, fine-grained deep marine siliciclastics, volcanics, a depositional environment characteristic having no sediment since a crust is not yet formed, and a depositional environment characteristic indicating subaqueous erosion, as indicated in column 304.

Referring back to FIG. 2, polygon pairs in the depositional environment 200 that fail the rule-base are flagged for correction. For example, if polygon 202A is assigned biosiliceous ooze/chert and if polygon 206A is assigned coarse-grained shallow lacustrine siliciclastics, then, as per the rule-base 300, the polygon pair 202A, 206A is determined to be incorrect and is flagged for correction. An attribute table that includes failed polygon pairs may be generated (and stored in the storage medium of the electronic device 702 and/or the server 706).

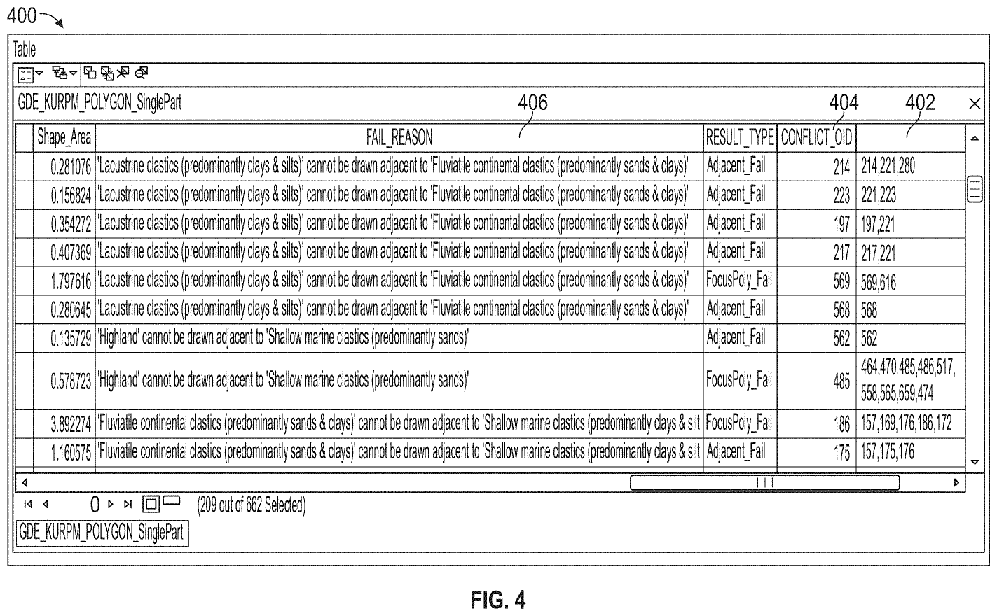

FIG. 4 illustrates part of an example attribute table 400, according to embodiments disclosed. As illustrated, column 402 includes identifiers (numeric identifiers, in this case) of one or more polygons determined to be adjacent to a given polygon (given polygon column not illustrated) and column 404 includes the identifier of an incorrect adjacent polygon from column 402. Column 406 includes the reason a polygon pair the adjacency test. The attribute table 400 thus indicates the conflicts (with respect to adjacency) between polygon pairs. One or more corrective actions may be performed to resolve the conflicts.

In an embodiment, the software application may provide guided correction to attribution of any adjacent polygons which fail the rule-base conditions. In an example, the software application may provide a list of different predetermined depositional environment characteristics which can be assigned to either of the conflicting polygons to resolve the conflict.

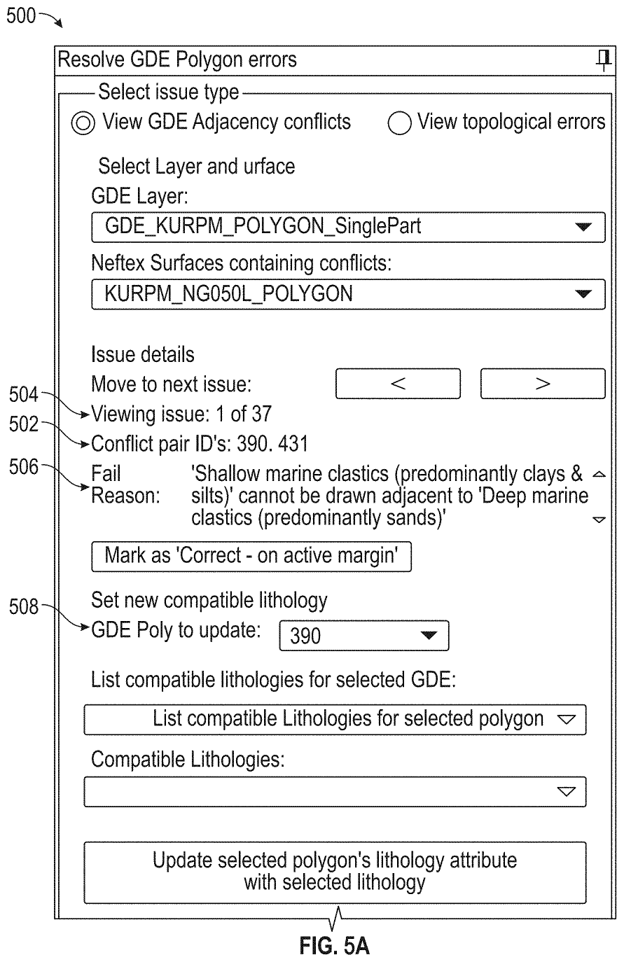

FIG. 5A illustrates an example GUI 500 provided by the software application indicating the conflicting polygon pairs, according to embodiments disclosed. As illustrated, the GUI 500 identifies the conflicting polygon pairs by their respective identifiers, at 502, and the total number of conflicts (37, in this case) determined based on the adjacency test, at 504. The GUI 500 also displays the reason that the polygon pairs have failed the rule-base, at 506. For instance, and as illustrated, the GUI 500 indicates that polygon pairs having identifiers 390 and 431 have failed because one of the polygons is assigned ‘Shallow marine elastics (predominantly clays & silts) and the other polygon is assigned ‘Deep marine clastics (predominantly sands),’ which may not be placed adjacent each other.

The software application also provides one or more corrective actions that may be taken to resolve the conflict. In an example, a corrective action may include changing the depositional environment characteristic of one of the conflicting polygons to a new depositional environment characteristic that is compatible with depositional environment characteristics of all the adjacent polygons. Stated otherwise, pairs including the new compatible depositional environment characteristic and the depositional environment characteristics of each adjacent polygon are included in the rule-base 300.

Referring to FIG. 5B, at 508, the GUI 500 may chose a polygon (having identifier 390, in this case) for which the depositional environment characteristic is to be changed, and request a list of lithologies that are compatible with all adjacent polygons from a drop down menu, at 510. At 512, one or more compatible lithologies may be provided. Referring to FIG. 5C, the user may update the lithology of the polygon with the selected lithology, at 514. When the lithology is changed, the conflict may be resolved. The user may then choose a different conflicting polygon pair for taking the necessary corrective actions.

Referring to FIG. 5D, in an embodiment, if no lithologies are compatible with all adjacent polygons, a corresponding message may be provided to the user, at 516 the user may resolve the conflict by creating one or more new polygons assigned depositional environment characteristics that are compatible with the conflicting polygon pair.

In another embodiment, the user may ignore the conflict by indicating that the polygon pair is not in conflict and provide a reason why the polygon pair is not believe to be in conflict. As an example, one reason may be a pre-existing cartographic error known to the user which causes the polygon pair to incorrectly appear in conflict.

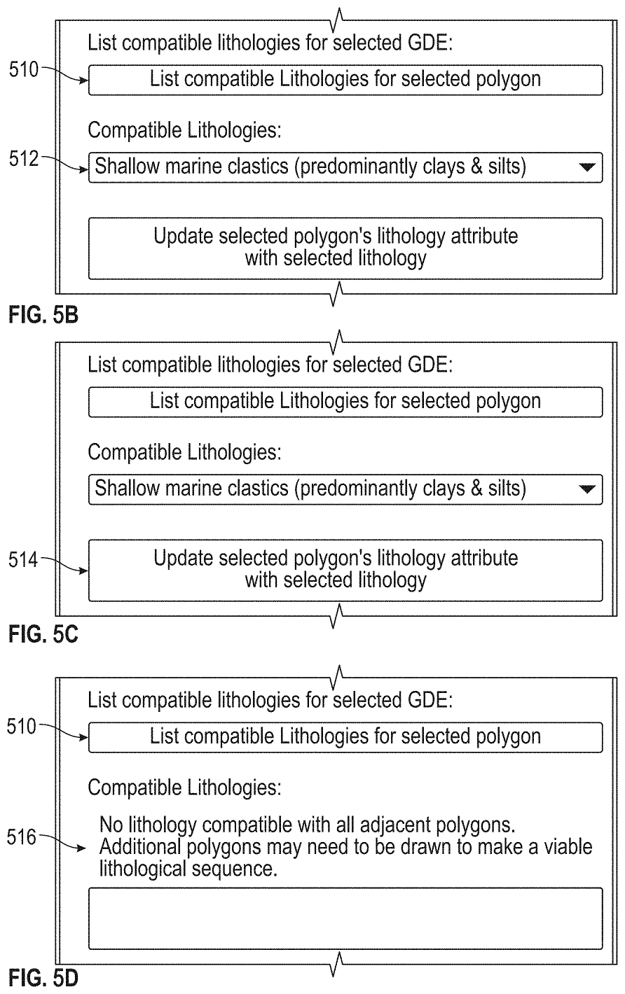

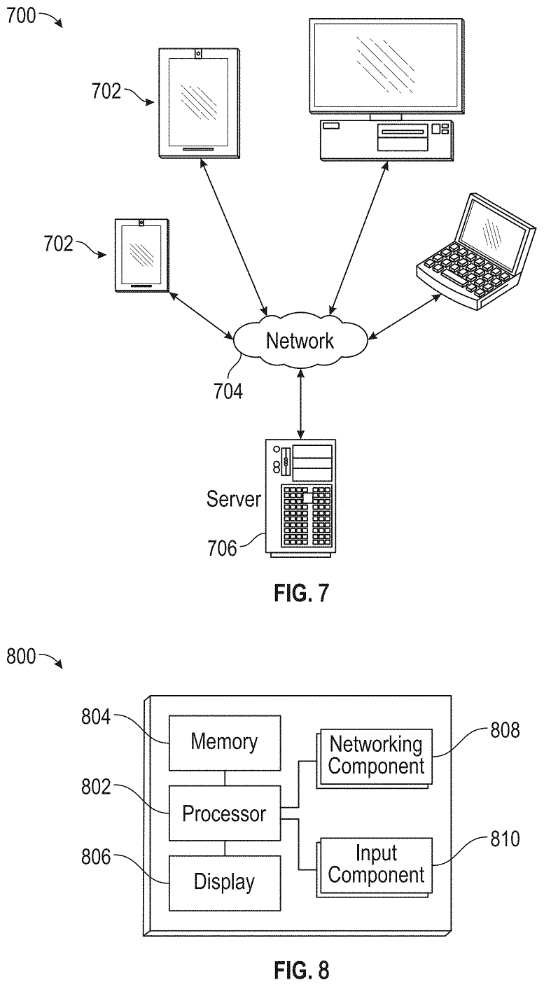

FIG. 6 conceptually illustrates an example flowchart of a process 600 for determining validity of an arrangement of a plurality of contiguous depositional environment polygons that depict a geological region, according to embodiments disclosed. Although FIG. 6 depicts functional steps in a particular sequence, the process is not necessarily limited to the particular order or steps illustrated. The various steps portrayed in FIG. 6 can be changed, rearranged, performed in parallel or adapted in various ways. Furthermore, it is to be understood that certain steps or sequences of steps can be added to or omitted from the process, without departing from the scope of the various embodiments. The process 600 may be implemented by one or more computing devices or systems in some embodiments, such as a computing device 800 described in FIG. 8, and/or electronic device 702 or server 706 described in FIG. 7.

The process 600 begins at block 602 by obtaining a plurality of polygons stored in a dataset of polygons. Each polygon of the plurality of polygons is assigned a different depositional environment characteristic, and the plurality of polygons represent the geological region. At block 604, the plurality of polygons are arranged adjacent each other using geographical coordinates of the polygons, and an arrangement of the plurality of polygons is obtained. At block 606, it is determined whether the arrangement of the plurality of polygons is valid using a rule-base that includes pairs of compatible depositional environment characteristics arranged adjacent each other, and, at block 608, a map of geological polygons for a region is generated for facilitating exploration of a natural resource.

As discussed herein, different approaches can be implemented in various environments in accordance with the described embodiments. For example, FIG. 7 illustrates an example network environment 700 in which a system for creating the depositional environment may be implemented in accordance with one or more embodiments. As will be appreciated, although a client-server based network environment is used for purposes of explanation, different network environments may be used, as appropriate, to implement various embodiments. The network environment 700 includes a client device, which can be an electronic device 702 and which can include any appropriate device operable to send and receive requests, messages or information over an appropriate network 704 and convey information back to a user of the electronic device 702. Examples of such an electronic device 702 may include, for example, a personal computer, a mobile device, a tablet device, a laptop computer, and the like.

The network 704 can include any appropriate network, including an intranet, the Internet, a cellular network, a local area network, a public network, a private network, or any other such network or combination thereof. The network 704 could be a “push” network, a “pull” network, or a combination thereof. In a “push” network, one or more of the servers push out data to the client device. In a “pull” network, one or more of the servers send data to the client device upon request for the data by the client device. Components used for such a system can depend at least in part upon the type of network and/or environment selected. Computing over the network 704 can be enabled via wired or wireless connections and combinations thereof. In this example, the network includes the Internet, as the environment includes a server 706 representing off-site computing facilities for receiving requests and serving content in response thereto, although for other networks, an alternative device serving a similar purpose could be used.

The server 706 typically will include an operating system that provides executable program instructions for the general administration and operation of that server and typically will include computer-readable medium storing instructions that, when executed by a processor of the server, allow the server to perform its intended functions. The network environment 700 in one or more embodiments is a distributed computing environment utilizing several computer systems and components that are interconnected via computing links, using one or more computer networks or direct connections. However, the depiction of the network environment 700 in FIG. 7 should be taken as being illustrative in nature and not limiting to the scope of the disclosure.

Storage media and other non-transitory computer readable media for containing code, or portions of code, can include any appropriate storage media used in the art, such as but not limited to volatile and non-volatile, removable and non-removable media implemented in any method or technology for storage of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store the desired information and which can be accessed by the electronic device 702 and/or the server 706.

The process of creating the depositional environment may be implemented by one or more (one shown) electronic devices 702 and/or the server 706. The electronic device 702 may execute a software application for creating the depositional environment, identifying conflicts in the created depositional environment, and providing corrective actions for resolving any conflicts. The application may be installed locally on the electronic device 702 or may be an internet-based application, such as a web application or a mobile application, and a user may access/interact with the software application via a user interface provided by the electronic device 702, such as a web browser.

FIG. 8 illustrates a schematic diagram of a set of general components of an example computing device 800. In this example, the computing device 800 includes a processor 802 for executing instructions that can be stored in a memory device or element 804. The computing device 800 can include many types of memory, data storage, or non-transitory computer-readable storage media, such as a first data storage for program instructions for execution by the processor 802, a separate storage for images or data, a removable memory for sharing information with other devices, etc.

The computing device 800 typically may include some type of display element 806, such as a touch screen or liquid crystal display (LCD). As discussed, the computing device 800 in many embodiments will include at least one input element 810 able to receive conventional input from a user. This conventional input can include, for example, a push button, touch pad, touch screen, wheel, joystick, keyboard, mouse, keypad, or any other such device or element whereby a user can input a command to the device. In some embodiments, however, such the computing device 800 might not include any buttons at all, and might be controlled only through a combination of visual and audio commands, such that a user can control the computing device 800 without having to be in contact with the computing device 800. In some embodiments, the computing device 800 of FIG. 8 can include one or more network interface elements 808 for communicating over various networks, such as a Wi-Fi, Bluetooth, RF, wired, or wireless communication systems. The computing device 800 in many embodiments can communicate with a network, such as the Internet, and may be able to communicate with other such computing devices.

Embodiments disclosed herein include:

Embodiment A. A method for determining validity of an arrangement of a plurality of contiguous depositional environment polygons that depict a geological region, comprising:

obtaining a plurality of polygons stored in a dataset of polygons, each polygon of the plurality of polygons assigned a different depositional environment characteristic, and the plurality of polygons representing the geological region; arranging the plurality of polygons adjacent each other using geographical coordinates of the polygons, and thereby obtain an arrangement of the plurality of polygons; determining whether the arrangement of the plurality of polygons is valid using a rule-base that includes pairs of compatible depositional environment characteristics arranged adjacent each other; and generating a map of geological polygons for a region that facilitates exploration of a natural resource.

Embodiment B. A device for obtaining a depositional environment of a geological region comprising: a processor; and a memory device including instructions that, when executed by the processor, direct the processor to: obtain a plurality of polygons stored in a dataset of polygons, each polygon of the plurality of polygons assigned a different depositional environment characteristic, and the plurality of polygons representing the geological region; arrange the plurality of polygons adjacent each other using geographical coordinates of the polygons, and thereby obtain an arrangement of the plurality of polygons; determine whether the arrangement of the plurality of polygons is valid using a rule-base that includes pairs of compatible depositional environment characteristics arranged adjacent each other; and generate a map of geological polygons for a region that facilitates exploration of a natural resource.

Embodiment C. A non-transitory computer-readable medium including instructions stored therein that, when executed by at least one computing device, direct the at least one computing device to: obtain a plurality of polygons stored in a dataset of polygons, each polygon of the plurality of polygons assigned a different depositional environment characteristic, and the plurality of polygons representing the geological region; arrange the plurality of polygons adjacent each other using geographical coordinates of the polygons, and thereby obtain an arrangement of the plurality of polygons; determine whether the arrangement of the plurality of polygons is valid using a rule-base that includes pairs of compatible depositional environment characteristics arranged adjacent each other; and generate a map of geological polygons for a region that facilitates exploration of a natural resource.

Each of embodiments A, B, and C may have one or more of the following additional elements in any combination. Element 1: wherein determining whether the arrangement of the plurality of polygons is valid comprises: comparing the depositional environment characteristic of a first polygon in the arrangement with the depositional environment characteristic of each polygon adjacent the first polygon, and thereby obtain one or more pairs of depositional environment characteristics, each pair including the depositional environment characteristic of the first polygon and the depositional environment characteristic of one of the adjacent polygons, and determining that the arrangement of the plurality of polygons is valid when each of the one or more pairs of depositional environment characteristics is included in the rule-base. Element 2: wherein obtaining the plurality of polygons comprises: obtaining the plurality of polygons including polygons each representing a same geological layer of the geological region and each assigned depositional environment characteristics from a same geological time. Element 3: wherein arranging the plurality of polygons adjacent each other includes arranging the plurality of polygons laterally adjacent each other. Element 4: further comprising: determining that the arrangement of the plurality of polygons is invalid when at least one pair of the one or more pairs of depositional environment characteristics is not included in the rule-base, and thereby obtain at least one conflicting polygon pair; and performing a corrective action when the arrangement of the plurality of polygons is invalid. Element 5: wherein performing the corrective action comprises: changing a depositional environment characteristic of at least one of a pair of depositional environment polygons to a different depositional environment characteristic that is compatible with depositional environment characteristics of all adjacent polygons. Element 6: further comprising: providing one or more predetermined depositional environment characteristics; and changing the depositional environment characteristic to one of the one or more predetermined depositional environment characteristics. Element 7: wherein performing the corrective action comprises: creating a new polygon having depositional environment characteristic compatible with the depositional environment characteristics of all adjacent polygons.

Element 8: wherein the instructions further direct the processor to: compare the depositional environment characteristic of a first polygon in the arrangement with the depositional environment characteristic of each polygon adjacent the first polygon, and thereby obtain one or more pairs of depositional environment characteristics, each pair including the depositional environment characteristic of the first polygon and the depositional environment characteristic of one of the adjacent polygons, and determining that the arrangement of the plurality of polygons is valid when each of the one or more pairs of depositional environment characteristics is included in the rule-base. Element 9: wherein the instructions further direct the processor to: obtain the plurality of polygons including polygons each representing a same geological layer of the geological region and each assigned depositional environment characteristics from a same geological time. Element 10: wherein the instructions further direct the processor to: arrange the plurality of polygons laterally adjacent each other. Element 11: wherein the instructions further direct the processor to: determine that the arrangement of the plurality of polygons is invalid when at least one pair of the one or more pairs of depositional environment characteristics is not included in the rule-base, and thereby obtain at least one conflicting polygon pair; and perform a corrective action when the arrangement of the plurality of polygons is invalid. Element 12: wherein to perform the corrective action, the instructions direct the processor to: change a depositional environment characteristic of the at least one pair depositional environment characteristics to a different depositional environment characteristic that is compatible with depositional environment characteristics of all adjacent polygons. Element 13: wherein the instructions further direct the processor to: provide one or more predetermined depositional environment characteristics; and change the depositional environment characteristic to one of the one or more predetermined depositional environment characteristics. Element 14: wherein to perform the corrective action, the instructions direct the processor to: create a new polygon having a depositional environment characteristic compatible with the depositional environment characteristics of all adjacent polygons.

Element 15: wherein executing the instructions further directs the at least one computing device to: compare the depositional environment characteristic of a first polygon in the arrangement with the depositional environment characteristic of each polygon adjacent the first polygon, and thereby obtain one or more pairs of depositional environment characteristics, each pair including the depositional environment characteristic of the first polygon and the depositional environment characteristic of one of the adjacent polygons, and determining that the arrangement of the plurality of polygons is valid when each of the one or more pairs of depositional environment characteristics is included in the rule-base. Element 16: wherein executing the instructions further directs the at least one computing device to: obtain the plurality of polygons including polygons each representing a same geological layer of the geological region and each assigned depositional environment characteristics from a same geological time. Element 17: wherein executing the instructions further directs the at least one computing device to: arrange the plurality of polygons laterally adjacent each other. Element 18: wherein executing the instructions further directs the at least one computing device to: determine that the arrangement of the plurality of polygons is invalid when at least one pair of the one or more pairs of depositional environment characteristics is not included in the rule-base, and thereby obtain at least one conflicting polygon pair; and perform a corrective action when the arrangement of the plurality of polygons is invalid. Element 19: wherein executing the instructions further directs the at least one computing device to: change a depositional environment characteristic of the at least one pair depositional environment characteristics to a different depositional environment characteristic that is compatible with depositional environment characteristics of all adjacent polygons. Element 20: wherein executing the instructions further directs the at least one computing device to: provide one or more predetermined depositional environment characteristics; and change the depositional environment characteristic to one of the one or more predetermined depositional environment characteristics. Element 21: wherein executing the instructions further directs the at least one computing device to: create a new polygon having a depositional environment characteristic compatible with the depositional environment characteristics of all adjacent polygons.

By way of non-limiting example, exemplary combinations applicable to embodiments A, B, and C include: Element 4 with Element 5; Element 4 with Element 7; Element 5 with Element 6; Element 11 with Element 12; Element 11 with Element 14; Element 12 with Element 13; Element 18 with Element 19; Element 18 with Element 21; and Element 19 with Element 20.

Various examples of aspects of the disclosure are described below as clauses for convenience. The methods of any preceding paragraph, either alone or in combination may further include the following clauses. These are provided as examples, and do not limit the subject technology.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the embodiments. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A method for determining validity of an arrangement of a plurality of contiguous depositional environment polygons that depict a geological region, comprising:
obtaining a plurality of polygons stored in a dataset of polygons, each polygon of the plurality of polygons assigned a different depositional environment characteristic, and the plurality of polygons representing the geological region;
arranging the plurality of polygons adjacent each other using geographical coordinates of the polygons, and thereby obtain an arrangement of the plurality of polygons;
determining whether the arrangement of the plurality of polygons is valid using a rule-base that includes pairs of compatible depositional environment characteristics arranged adjacent each other; and
generating a map of geological polygons for a region that facilitates exploration of a natural resource.

2. The method of claim 1, wherein determining whether the arrangement of the plurality of polygons is valid comprises:
comparing the depositional environment characteristic of a first polygon in the arrangement with the depositional environment characteristic of each polygon adjacent the first polygon, and thereby obtain one or more pairs of depositional environment characteristics, each pair including the depositional environment characteristic of the first polygon and the depositional environment characteristic of one of the adjacent polygons, and determining that the arrangement of the plurality of polygons is valid when each of the one or more pairs of depositional environment characteristics is included in the rule-base.

3. The method of claim 1, wherein obtaining the plurality of polygons comprises:
obtaining the plurality of polygons including polygons each representing a same geological layer of the geological region and each assigned depositional environment characteristics from a same geological time.

4. The method of claim 1, wherein arranging the plurality of polygons adjacent each other includes arranging the plurality of polygons laterally adjacent each other.

5. The method of claim 1, further comprising:
determining that the arrangement of the plurality of polygons is invalid when at least one pair of the one or more pairs of depositional environment characteristics is not included in the rule-base, and thereby obtain at least one conflicting polygon pair; and performing a corrective action when the arrangement of the plurality of polygons is invalid.

6. The method claim 5, wherein performing the corrective action comprises:
changing a depositional environment characteristic of at least one of a pair of depositional environment polygons to a different depositional environment characteristic that is compatible with depositional environment characteristics of all adjacent polygons.

7. The method claim 6, further comprising:
providing one or more predetermined depositional environment characteristics; and
changing the depositional environment characteristic to one of the one or more predetermined depositional environment characteristics.

8. The method claim 5, wherein performing the corrective action comprises:
creating a new polygon having depositional environment characteristic compatible with the depositional environment characteristics of all adjacent polygons.

9. A device for determining validity of an arrangement of a plurality of contiguous depositional environment polygons that depict a geological region, comprising:
a processor; and
a memory device including instructions that, when executed by the processor, direct the processor to:
obtain a plurality of polygons stored in a dataset of polygons, each polygon of the plurality of polygons assigned a different depositional environment characteristic, and the plurality of polygons representing the geological region;
arrange the plurality of polygons adjacent each other using geographical coordinates of the polygons, and thereby obtain an arrangement of the plurality of polygons;
determine whether the arrangement of the plurality of polygons is valid using a rule-base that includes pairs of compatible depositional environment characteristics arranged adjacent each other; and
generate a map of geological polygons for a region that facilitates exploration of a natural resource.

10. The device of claim 9, wherein the instructions further direct the processor to:
compare the depositional environment characteristic of a first polygon in the arrangement with the depositional environment characteristic of each polygon adjacent the first polygon, and thereby obtain one or more pairs of depositional environment characteristics, each pair including the depositional environment characteristic of the first polygon and the depositional environment characteristic of one of the adjacent polygons, and determining that the arrangement of the plurality of polygons is valid when each of the one or more pairs of depositional environment characteristics is included in the rule-base.

11. The device of claim 9, wherein the instructions further direct the processor to:
obtain the plurality of polygons including polygons each representing a same geological layer of the geological region and each assigned depositional environment characteristics from a same geological time.

12. The device of claim 9, wherein the instructions further direct the processor to:
arrange the plurality of polygons laterally adjacent each other.

13. The device of claim 9, wherein the instructions further direct the processor to:
determine that the arrangement of the plurality of polygons is invalid when at least one pair of the one or more pairs of depositional environment characteristics is not included in the rule-base, and thereby obtain at least one conflicting polygon pair; and
perform a corrective action when the arrangement of the plurality of polygons is invalid.

14. The device of claim 13, wherein to perform the corrective action, the instructions direct the processor to:
change a depositional environment characteristic of the at least one pair depositional environment characteristics to a different depositional environment characteristic that is compatible with depositional environment characteristics of all adjacent polygons.

15. The device of claim 14, wherein the instructions further direct the processor to:
provide one or more predetermined depositional environment characteristics; and
change the depositional environment characteristic to one of the one or more predetermined depositional environment characteristics.

16. The device of claim 13, wherein to perform the corrective action, the instructions direct the processor to:
create a new polygon having a depositional environment characteristic compatible with the depositional environment characteristics of all adjacent polygons.

17. A non-transitory computer-readable medium including instructions stored therein that, when executed by at least one computing device, direct the at least one computing device to:
obtain a plurality of polygons stored in a dataset of polygons, each polygon of the plurality of polygons assigned a different depositional environment characteristic, and the plurality of polygons representing a geological region;
arrange the plurality of polygons adjacent each other using geographical coordinates of the polygons, and thereby obtain an arrangement of the plurality of polygons;
determine whether the arrangement of the plurality of polygons is valid using a rule-base that includes pairs of compatible depositional environment characteristics arranged adjacent each other; and
generate a map of geological polygons for a region that facilitates exploration of a natural resource.

18. The non-transitory computer-readable medium of claim 17, wherein executing the instructions further directs the at least one computing device to:
compare the depositional environment characteristic of a first polygon in the arrangement with the depositional environment characteristic of each polygon adjacent the first polygon, and thereby obtain one or more pairs of depositional environment characteristics,
each pair including the depositional environment characteristic of the first polygon and the depositional environment characteristic of one of the adjacent polygons, and determining that the arrangement of the plurality of polygons is valid when each of the one or more pairs of depositional environment characteristics is included in the rule-base.

19. The non-transitory computer-readable medium of claim 17, wherein executing the instructions further directs the at least one computing device to:
obtain the plurality of polygons including polygons each representing a same geological layer of the geological region and each assigned depositional environment characteristics from a same geological time.

20. The non-transitory computer-readable medium of claim 17, wherein executing the instructions further directs the at least one computing device to:
arrange the plurality of polygons laterally adjacent each other.

21. The non-transitory computer-readable medium of claim 17, wherein executing the instructions further directs the at least one computing device to:
determine that the arrangement of the plurality of polygons is invalid when at least one pair of the one or more pairs of depositional environment characteristics is not included in the rule-base, and thereby obtain at least one conflicting polygon pair; and
perform a corrective action when the arrangement of the plurality of polygons is invalid.

22. The non-transitory computer-readable medium of claim 21, wherein executing the instructions further directs the at least one computing device to:
change a depositional environment characteristic of the at least one pair depositional environment characteristics to a different depositional environment characteristic that is compatible with depositional environment characteristics of all adjacent polygons.

23. The non-transitory computer-readable medium of claim 22, wherein executing the instructions further directs the at least one computing device to:
provide one or more predetermined depositional environment characteristics; and
change the depositional environment characteristic to one of the one or more predetermined depositional environment characteristics.

24. The non-transitory computer-readable medium of claim 21, wherein executing the instructions further directs the at least one computing device to:
create a new polygon having a depositional environment characteristic compatible with the depositional environment characteristics of all adjacent polygons.
